(19) United States
(12) Patent Application Publication
(10) Pub. No.: US 2003/0052932 A1
(43) Pub. Date: Mar. 20, 2003

(54) INK JET RECORDING HEAD AND RECORDING APPARATUS CARRYING THE HEAD THEREON

(76) Inventors: SEIICHIRO KARITA, KANAGAWA-KEN (JP); YUTAKA KOIZUMI, KANAGAWA-KEN (JP); JUNJI YASUDA, KANAGAWA-KEN (JP)

Correspondence Address: FITZPATRICK CELLA HARPER & SCINTO, 30 ROCKEFELLER PLAZA, NEW YORK, NY, 10112, US

(21) Appl. No.: 09/222,845

(22) Filed: Dec. 30, 1998

(30) Foreign Application Priority Data
Jan. 12, 1998 (JP) 10-004008

(51) Int. Cl. B41J 29/38

(52) U.S. Cl. 347/14

(57) ABSTRACT

This specification discloses an ink jet recording head in which discharge energy is imparted from a plurality of discharge energy generating elements formed on an element substrate and ink in an ink flow path is discharged from a nozzle, characterized in that a driving element for driving the discharge energy generating elements and also having the function as a temperature sensor and formed as a member discrete from the element substrate is mounted on the element substrate. The specification also discloses a recording apparatus having signal transmitting means for driving the ink jet recording head.

### BACKGROUND OF THE INVENTION

1. Field of the Invention

This invention relates to an ink jet recording head and a recording apparatus.

2. Related Background Art

For example, a thermal recording system, an ink jet recording system, etc., have heretofore been adopted as the recording system of a recording apparatus such as a printer. The thermal recording system is a system which uses a heat generating element to make heat act on thermosensitive paper and cause coloring or melt the ink of an ink ribbon and transfer it to a recording medium to thereby effect recording.

Also, the ink jet recording system is a recording system which causes ink to be discharged from a nozzle (discharge port) disposed in an ink jet recording head, and causes the ink to adhere to a recording material such as paper to thereby effect recording, and suffers very little from the occurrence of noise and can accomplish high-speed recording and has recently widely spread. As the ink jet recording head, there is known one provided with a piezoelectric element or a heat generating element. Particularly, a recording head of the so-called bubble jet type which has a heat generating element and causes heat energy to act on ink and suddenly heats the ink to thereby create a bubble, and jets the ink in an ink flow path as a liquid droplet from a nozzle by the expansion of volume by the bubbling, and introduces the ink from an ink chamber into the ink flow path during the disappearance of the bubble, has the merits that it is good in the responsiveness to a recording signal and that it is easy to make it highly dense.

To effect image formation of high dignity in such an ink jet recording head, it is necessary to keep the amount of discharged liquid droplet per each ink discharge constant to the utmost. This amount of discharged liquid droplet is governed by the temperature of the recording head, but the temperature of particularly a recording head comprised of a heat generating element disposed therein is varied by the difference in duty (the duty of a driving signal) conforming to data to be recorded or a change in environmental temperature. So, there has heretofore been adopted a construction in which provision is made of a temperature sensor exclusively for detecting the temperature of the recording head, and any temperature change is monitored by this temperature sensor and correspondingly to the result of the monitoring, a heater is heated or a printing speed is controlled to thereby control the temperature of the recording head so as to be kept constant, thereby achieving the uniformization of the amount of discharged liquid droplet and further a higher quality of image.

As an example of such an ink jet recording head, a so-called long head having a number of discharge ports (nozzles) is shown in FIGS. 1 and 2 of the accompanying drawings. Briefly describing this construction, a flow path substrate 13 formed with an ink flow path 16 is laminated on and secured to an element substrate 21 provided with a plurality of heat generating elements 12 which are discharge energy generating means, and the heat generating elements 12 are located in respective nozzles 17. A plurality of driving elements 18 for driving the heat generating elements 12 independently of each other are provided on the element substrate 21, and the tip end of the ink flow path 16 which is supplied with ink from ink supply tubes 22A and 22B through ink supply joints 20A and 20B provides the nozzles 17. The laminated element substrate 21 and flow path substrate 13 are disposed on a holding substrate 14. A circuit substrate 15 is also provided on the holding substrate 14, and the circuit substrate 15 and the element substrate 21 are connected together by a bonding wire 19. Mounting portions 23 are provided on the holding substrate 14 at several locations in the direction of row of the nozzles 17, and by these mounting portions 23, a temperature sensor (thermistor) 24 for detecting the temperature of the recording head is mounted while facing the heat generating elements 12. The mounting portions 23 are formed of solidified paste of good heat conductivity, and are quickened in the heat conduction to the temperature sensor 24. The result of the temperature detection by the temperature sensor 24 is transmitted to control means, not shown, through wiring 25 creeping on the underside of the holding substrate 14.

According to the above-described example of the construction, the temperature control of the recording head is possible by the utilization of the temperature sensor 24, but the step of working a space for mounting the temperature sensor 24 on the holding substrate 14, or mounting in that space the temperature sensor 24 using the mounting portions 23 formed of paste is cumbersome and the working property is bad, and this construction is unsuitable for mass production and leads to a high manufacturing cost. There is also the problem that the temperature sensor 24 itself is expensive.

Also, in the construction according to the prior art, the temperature sensor has been disposed very near to the heat generating element of the recording head so that the accuracy of the detection of heat may be maintained high and quick driving control may be executed. However, in the size of the ink jet recording head, there is no such great difference in the transfer of heat from the heat generating element between an area very near to the heat generating element and an area far from the heat generating element that substantially a problem arises.

Accordingly, it is possible to effect temperature detection on the element substrate far from the location at which the heat generating element is disposed.

Now, a driving element is disposed on the element substrate constituting the recording head. This driving element is a semiconductor element and therefore a diode can be easily made therein. I have come to the idea that if so, the temperature characteristic of the diode made in the driving element is utilized, whereby the diode can be made to function as a diode sensor and the driving element can be used also as a temperature detecting element.

### SUMMARY OF THE INVENTION

The present invention has been made on the basis of the above-described idea and an object thereof is to provide a recording head and a recording apparatus in which a drive is made in a driving element and it is utilized as a temperature sensor and is mounted on the element substrate of the recording head to thereby effect the detection of the temperature of the recording head and the dignity of recording can be improved.

It is also an object of the present invention to provide an ink jet recording head and a recording apparatus which can reliably effect temperature detection and can eliminate the step of mounting a temperature sensor for exclusive use and which is low in cost and simple to manufacture and which can improve productivity and is capable of effecting temperature control.

The present invention is an ink jet recording head in which discharge energy is imparted from a plurality of discharge energy generating elements formed on an element substrate and ink in an ink flow path is discharged from a nozzle, characterized in that a driving element for driving the discharge energy generating elements and also having the function as a temperature sensor and formed as a member discrete from the element substrate is mounted on the element substrate.

The ink discharging operation is controlled on the basis of the result of the temperature detection by the driving element.

The discharge energy generating elements are heat generating elements.

The recording apparatus of the present invention has the ink jet recording head of the aforedescribed construction.

Thus, a temperature sensor for exclusive use as a member discrete from the element substrate and the driving element becomes unnecessary, and productivity and cost can be improved. It is possible to find the temperature of the recording head directly concerned in ink discharge on the basis of the result of the temperature detection by the driving element.

### BRIEF DESCRIPTION OF THE DRAWINGS

FIG. 1 is a perspective view of an ink jet recording head according to the prior art.

FIG. 2 is a fragmentary enlarged cross-sectional view of the ink jet recording head of FIG. 1.

FIG. 3 is a schematic top plan view of an embodiment of the ink jet recording head of the present invention.

FIG. 4A is a schematic view of the vicinity of a driving element showing the circle 4A of FIG. 3 taken out with a spring member removed, and FIG. 4B is a cross-sectional view taken along the line 4B-4B of FIG. 4A.

FIGS. 5A and 5B are schematic views showing an example of the joint between the driving element and a substrate.

FIG. 6 is a graph showing an example of the relation between the detection temperature by the driving element and the temperature of the recording head.

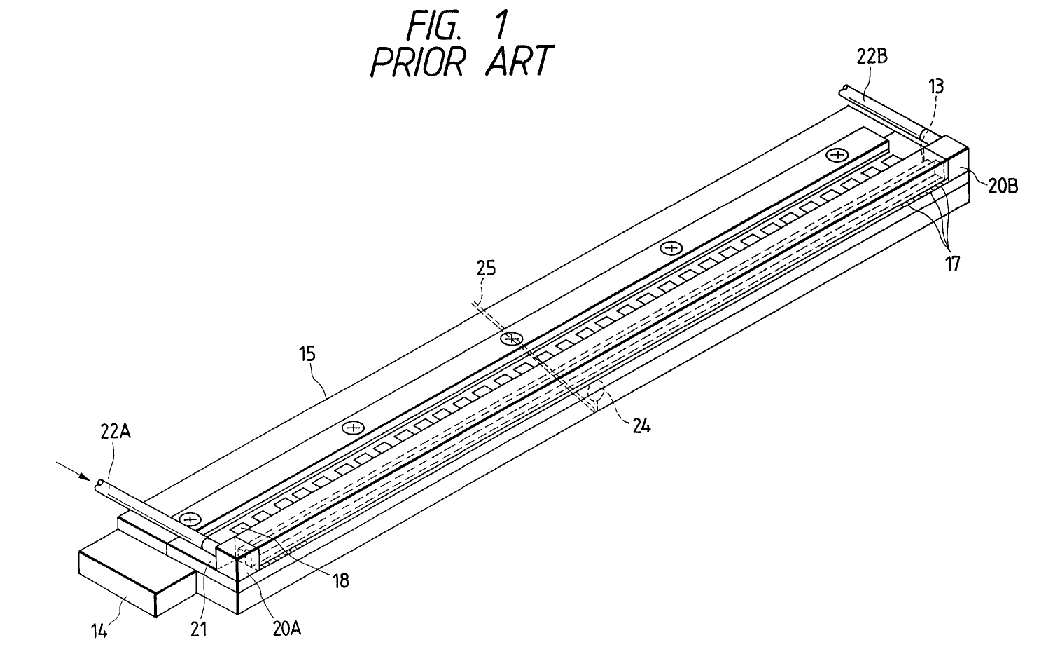

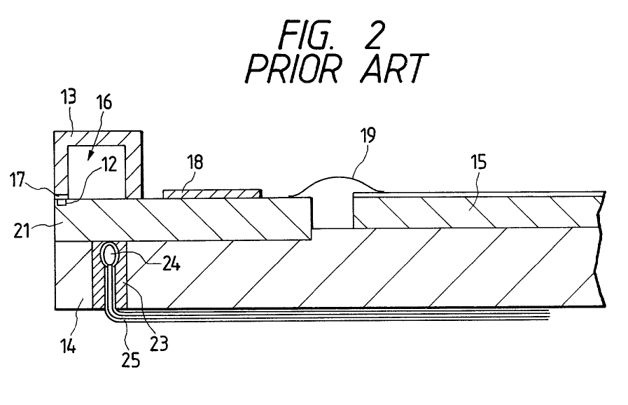

### DESCRIPTION OF THE PREFERRED EMBODIMENT

An embodiment of the present invention will hereinafter be described with reference to the drawings.

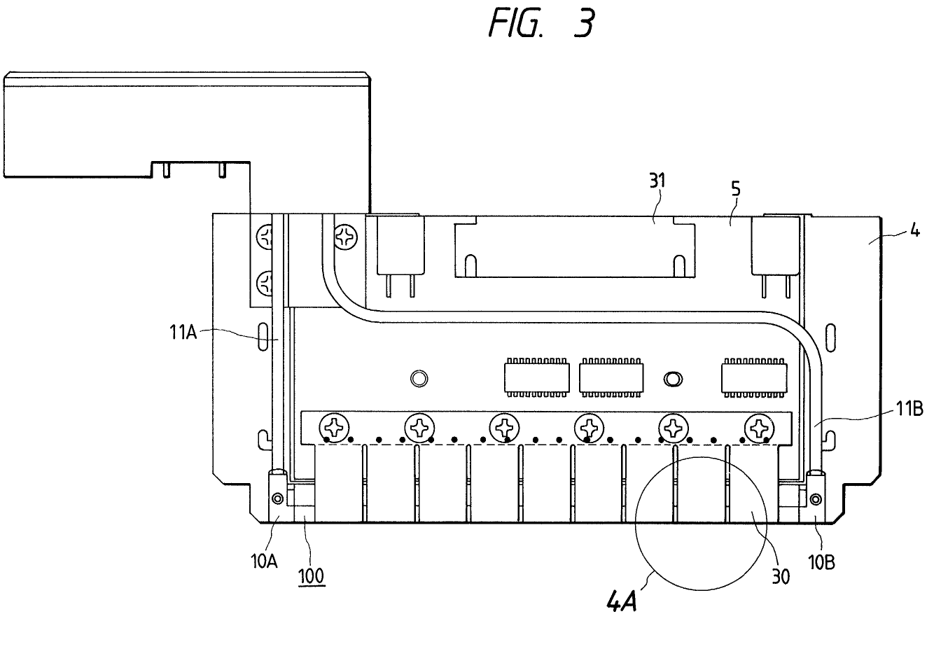

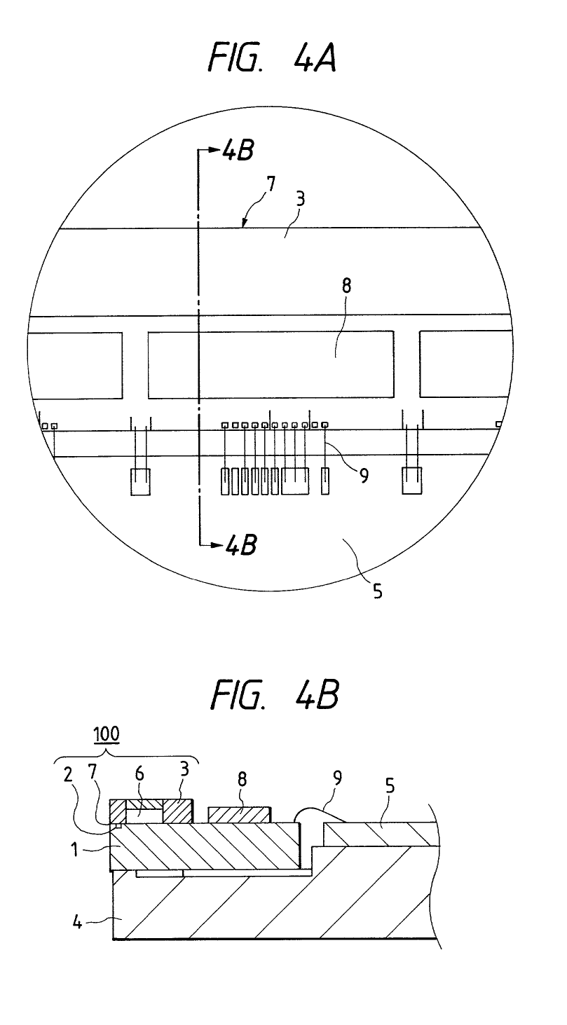

As shown in FIGS. 3, 4A and 4B, a flow path substrate 3 formed with an ink flow path 6 is laminated on and secured to an element substrate 1 of aluminum on which are provided a plurality of heat generating elements 2 which are discharge energy generating means, and the heat generating elements 2 are located in the ink flow path 6. A plurality of driving elements 8 for driving the heat generating elements 2 independently of one another are provided on the element substrate 1, and the heat generating elements 2 and the driving elements 8 are electrically connected together by a conduction pattern (a wiring pattern of Al or the like formed by film forming technique), not shown. The tip end of the ink flow path 6 through which ink flows from ink supply tubes 11A and 11B through ink supply couplings joints 10A and 10B provides a nozzle (discharge port) 7. Filters are disposed in the ink supply couplings to prevent the entry of dust from the outside. The laminated element substrate 1 and flow path substrate 3 are fixed onto a holding substrate 4. A circuit substrate 5 is also fixed to the holding substrate 4, and the circuit substrate 5 and the element substrate 1 are connected together by a bonding wire 9. The circuit substrate 5 effects the exchange of electrical signals with control means, not shown, disposed on a recording apparatus side, through a print cable or the like, not shown. Accordingly, electrical conduction is established from the control means to the heat generating elements 2 through the print cable connected to the control means, a connector 31, the circuit substrate 5, the bonding wire 9 and the driving elements 8. A pressure bar spring 30 is provided above the discharge element to aid in the close contact of the nozzle portion. FIG. 4A is a top plan view of a location designated by a circle 4A in FIG. 3 with the keep spring removed, and FIG. 4B is a cross-sectional view taken along the line 4B-4B of FIG. 4A.

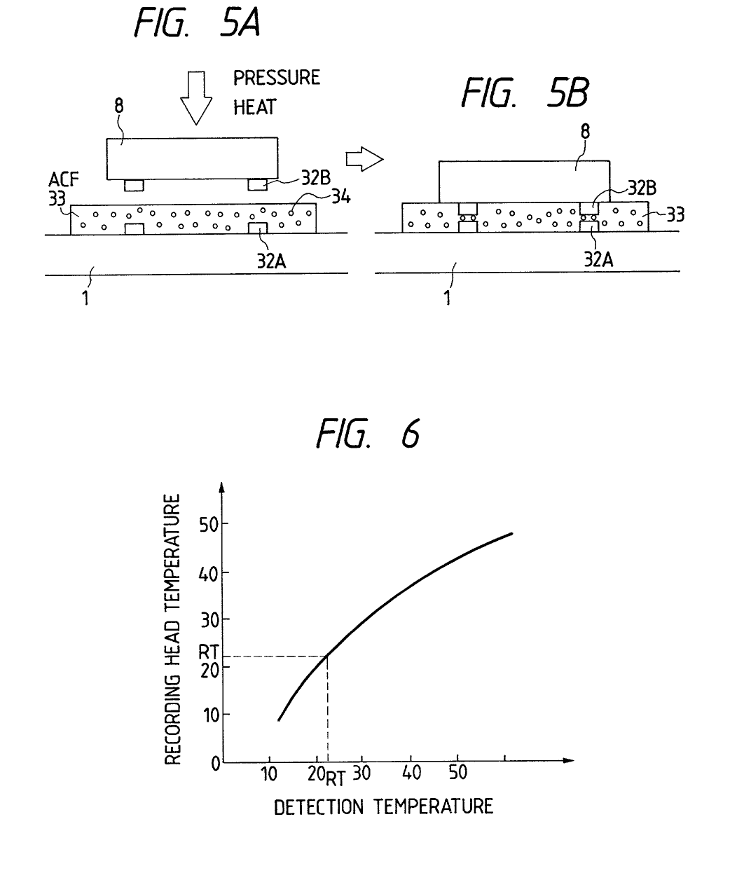

The driving elements 8 of the present invention have the function of a temperature sensor. Specifically, an integrated circuit including a diode sensor using the temperature characteristic of a diode is used as each driving element 8. These driving elements 8 are directly mounted on the element substrate 1 by the flip chip mounting technique. As an example of the construction mounted by ACF mounting is shown in FIG. 5, an ACF 33 is disposed on a bump 32A on the substrate side, and the bump 32B of each driving element is aligned therewith, and the ACF 33 is mounted by pressure/heat. The ACF 33 includes metallic particles 34 therein, whereby the connection between the bumps is done. The circuit forming surfaces of the driving elements 8 are mounted so as to be opposed to that surface of the substrate 1 on which the heat generating elements 2 are formed.

The operation of this ink jet recording head will now be described.

When a recording signal is supplied from the control means, not shown, this recording signal is transmitted to the driving elements 8 through the print cable, not shown, the circuit substrate 5 and the bonding wire 9, and on the basis of this recording signal, the driving elements 8 drive the heat generating elements 2. When the driven heat generating elements 2 generate heat, the ink in the ink flow path 6 becomes high in temperature and creates a bubble. At this time, by the increase in volume by this bubble creation, the ink is discharged from the nozzle 7 toward an outside recording medium (not shown) and recording is effected. At that time, the diode sensors in the driving elements 8 effect temperature detection, and the result of the temperature detection is transmitted to a control circuit, not shown, through the circuit substrate 5, etc. In the control circuit, data as shown in the graph of FIG. 6 wherein the detection temperature by the driving elements 8 and the temperature of the recording head concerned in the actual ink discharge are made to correspond to each other is stored as a table. Accordingly, the control circuit finds the temperature of the recording head from the result of the temperature detection by the driving elements 8 having the function of a temperature sensor, and controls the driving (such as generated heat temperature, driving frequency and discharge speed) of the heat generating elements 2, and effects the heating of the recording head by a heater, not shown. When during recording, the result of temperature detection changes with the heat generation of the heat generating elements 2 and the driving elements 8 themselves or a change in the environmental temperature, control is effected by coping with it on real time. To cope with a temperature change more accurately, it is preferable to find the relation as shown in FIG. 6 at each environmental temperature.

According to the present invention, the driving elements 8 can be given the function of a temperature sensor by the same step without changing the manufacturing step of the driving elements 8, and temperature control becomes possible without increasing the cost. Thus, a temperature sensor is provided in opposed relationship with the surface of the element substrate 1 and therefore, the temperature of the element substrate 1 at a distance from the heat generating elements 2 can also be detected by this sensor.

Also, the driving elements 8 are given the function of a temperature sensor and these elements are mounted on the element substrate of the head, whereby good driving elements can be chosen and mounted on a good head and therefore, a good head can be obtained easily.

While the head of the above-described construction has been described with respect to a head of a long type provided with a number of nozzles, the present invention is of course not restricted thereto. In the head of a long type, however, it is more preferable to take it into consideration from the difficulty of the manufacture of the head that good driving elements and a good head are combined together, whereby a head can be completed.

The head of such a long type can of course be constructed by the use of not only an element substrate made of aluminum, but also a substrate made of silicon. Again in this case, it is preferable to adopt the construction in which the driving elements are mounted as discrete members and are used also as temperature sensors.

As described above, according to the present invention, the driving elements are given the function of a temperature sensor and detect temperature, whereby the temperature of the recording head can be known and control conforming to this temperature of the recording head can be effected. Thereby, the uniformization of the amount of discharge liquid droplet is possible and recording of high quality can be effected stably. Moreover, cost and productivity can be greatly improved.

What is claimed is:

1. An ink jet recording head in which discharge energy is imparted from a plurality of discharge energy generating elements formed on an element substrate and ink in an ink flow path is discharged from a nozzle, characterized in that a driving element for driving said discharge energy generating elements and also having the function as a temperature sensor and formed as a member discrete from said element substrate is mounted on said element substrate.

2. An ink jet recording head according to claim 1, wherein the ink discharging operation is controlled on the basis of the result of the temperature detection by said driving element.

3. An ink jet recording head according to claim 1 or 2, wherein said discharge energy generating elements are heat generating elements.

4. A recording apparatus having signal transmitting means for driving an ink jet recording head according to claim 1.
